(19) United States
(12) Patent Application Publication
(10) Pub. No.: US 2008/0083495 A1
(43) Pub. Date: Apr. 10, 2008

(54) Method of Manufacturing Structured Release Liner

(75) Inventors: Frank T. Sher, St. Paul, MN (US); David J. Yarusso, Shoreview, MN (US); Michael R. Kesti, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/470,069

(22) Filed: Sep. 5, 2006

(51) Int. Cl. B32B 37/12; B32B 37/26; B05D 3/00

(52) U.S. Cl. 156/289; 427/274; 427/277; 427/271

(57) ABSTRACT

Disclosed herein is a method of manufacturing a structured release liner. The method includes providing a base; providing a ridge-forming material; coating the ridge-forming material on the base; forming the ridge-forming material into at least one ridge using a coating bar having a profile; and solidifying the ridge-forming material. Coating the ridge-forming material on the base and forming the ridge-forming material into the at least one ridge using a coating bar may be carried out simultaneously.

### FIELD

The present application is directed to a method of manufacturing structured release liners, and particularly, to a coating process for forming structured release liners.

### BACKGROUND

Pressure sensitive adhesives are useful for the joining of two materials. The interfaces between the adhesive and the materials are vital to the performance of the joined materials. The loss of adhesion at either interface can doom the usage of the materials. Adhesives have been structured in the past for various reasons.

Several approaches to structuring adhesives are known, including those shown in, for example, U.S. Pat. Nos. 5,296,277 and 5,362,516 (both Wilson et al.); U.S. Pat. Nos. 5,141,790 and 5,897,930 (both Calhoun et al.); and U.S. Pat. No. 6,197,397 (Sher et al.). These patents disclose how the structure in the adhesive is built from the interface between the adhesive and the release liner.

These release liners are generally manufactured by structuring a thermoplastic polymer surface of the liner. Current methods of making release liners having microstructured patterns include cast extrusion onto a microstructured tool that imparts the desired pattern to the liner followed by silicone release coating where required, or by embossing. i.e. pressing, a pattern into a thermoplastic polymer surface, with or without a silicone release coating, between structured nips to impart a pattern. These manufacturing steps form the topography on the liner, which is then used to impart topography into an adhesive. These steps require durable patterned tools, appropriate equipment, and materials suitable for these processes that can provide stable topography for further processing and use.

### SUMMARY

Disclosed herein is a method of manufacturing a structured release liner. The method of manufacturing the structured release liner comprises: providing a base; providing a ridge-forming material; coating the ridge-forming material on the base; forming the ridge-forming material into at least one ridge using a coating bar having a profile; and solidifying the ridge-forming material. Coating the ridge-forming material on the base and forming the ridge-forming material into at least one ridge using a coating bar may be carried out simultaneously.

The method may further comprise contacting the structured surface formed by the at least one ridge with an adhesive, for example, with an adhesive layer. The adhesive is then structured by the structured release liner, and the structured adhesive article thus formed may then be separated from the structured release liner. The structured adhesive article may be used in a variety of applications, including applications in which microstructured adhesive films are employed.

The method is particularly advantageous because a structured release liner may be prepared without the need for expensive tools and equipment and is amenable to a variety of materials which may be selected depending on end use.

These and other aspects of the invention will be apparent from the drawings, detailed description, and the claims. In no event, should the above summary be construed as a limitation on the claimed subject matter.

### BRIEF DESCRIPTION OF THE DRAWINGS

FIGS. 1a and 1b show an elevated view and a cross-sectional view, respectively, of an exemplary structured release liner.

FIGS. 2a and 2b show cross-sectional views of exemplary laminate constructions formed using the structured release liner of FIGS. 1a and 1b.

FIG. 3 shows a cross-sectional view of a structured adhesive film formed from the laminate construction of either FIG. 2a or 2b.

### DETAILED DESCRIPTION

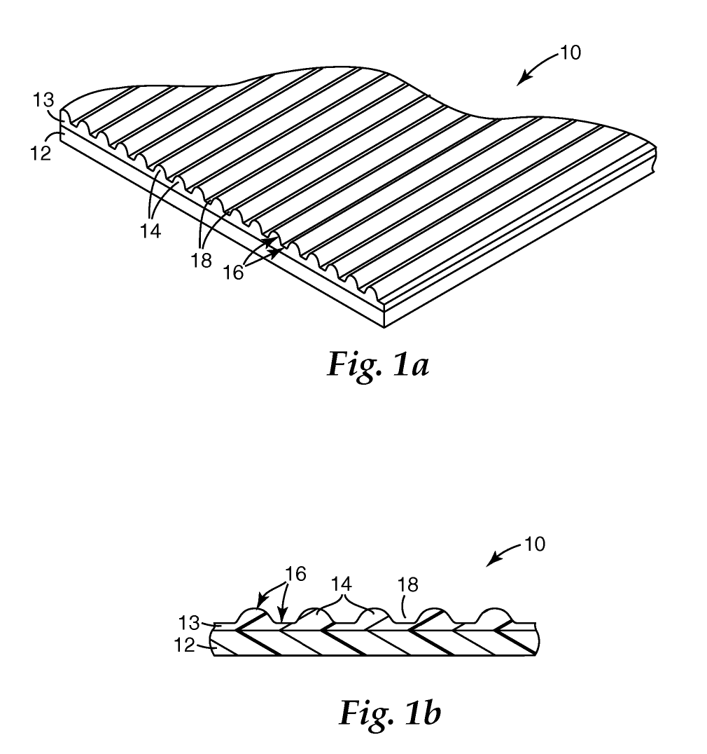

FIG. 1a shows an elevated view of exemplary structured release liner 10 comprising base 12 and ridge-containing layer 13. The ridge-containing layer 13 comprises at least one ridge 14 and region 18 is present between two adjacent ridges. Structured surface 16 is formed by the at least one ridge. FIG. 1b shows a cross sectional view of the structured release liner shown in FIG. 1a.

The structured release liner disclosed herein may be manufactured using a variety of coating methods. Generally, a ridge-forming material is coated on a base and a coating bar having a profile is used to structure the surface of the coating into at least one ridge. The resulting structured coating is then solidified to form the structured release liner.

Useful coating methods include spread coating techniques such as flood coating or spray coating. The coating means and the profiled coating bar may be integrated into one device such as a coating die with a profiled die lip.

The ridges may be formed by coating the surface of the base with the ridge-forming material, and then passing the coated base under the coating bar. The ridges may also be formed by providing a reservoir of the ridge-forming material onto a leading portion of the base, and then passing the coating bar over the base such that the ridge-forming material is coated and formed into ridges simultaneously. In either case, the coated base, with or without the ridge-forming material, may be held stationary while the coating bar is moved. It is also possible to keep the coating bar stationary and move the base with or without the ridge-forming material. Combinations of these two methods may also be used.

The structured release liner comprises at least one ridge and may comprise multiple ridges that extend in a substantially parallel relationship with respect to one another in a single direction along the base. Preferably, the coating is substantially continuous on the base, and each ridge is substantially continuous in the single direction along the base.

The ridges may have any shape when viewed in cross section, for example, square, triangular, rectangular, diamond, hexagonal, semi-circular, trapezoidal, etc.

The height of any ridge is the difference between the top of the ridge and the average plane of the surfaces of the coating between adjacent ridges. The height is not particularly limited and may depend upon the application in which the structured release liner will be used. In graphic arts applications in which air bleed is important, the ridges may have a height of greater than about 3 micrometers, for example greater than about 5 micrometers, or greater than about 7 micrometers. The ridges may have a height of less than about 500 micrometers, for example, less than about 45 micrometers, less than about 35 micrometers, or less than about 25 micrometers.

The width of any ridge, at the widest point when viewed as a cross-section, is not particularly limited and may depend upon the application in which the structured release liner will be used. The ridges may have a width of greater than about 15 micrometers, for example greater than about 25 micrometers and in specific embodiments greater than about 50 micrometers. The ridges may have a width of less than about 2000 micrometers, for example less than about 300 micrometers, less than about 200 micrometers, or less than about 150 micrometers.

The ridges may be wider than they are high, or the width and the height may be substantially equivalent. Or, the ridges may be higher than they are wide.

The distance between adjacent ridges may vary considerably, depending on, for example, the extent to which the ridge-forming material flows before being solidified. Considering a cross-sectional view of a ridge, a center point may be defined as a point on a line that divides the ridge in half in the height direction. The distance between the center points of adjacent ridges may be greater than about 150 micrometers, for example greater than about 170 micrometers, or greater than about 200 micrometers. The distance between center points may be less than about 5100 micrometers, for example less than about 2500 micrometers, or less than about 1700 micrometers. For example, the at least one ridge may comprise a first ridge disposed adjacent a second ridge, the first ridge having a first center point, the second ridge having a second center point, and the distance between the first and second center points is from about 150 micrometers to about 5100 micrometers.

The specific dimensions described above may be selected to provide the desired performance, including, for example, visibility, air bleedability, and adhesion.

After the at least one ridge is formed, the ridge-forming material is solidified in order to maintain the structured shape. Solidification may be carried out by cooling, drying, and/or curing, and the method used will depend upon the particular ridge-forming material being used. For example, the ridge-forming material may be a thermoplastic material which is in a molten state while the ridges are formed, and solidification would then by carried out by cooling the material. Cooling means may comprise a chill roll or a stream of cooled air.

The ridge-forming material may be dissolved, dispersed or suspended in a solvent or water while the ridges are formed, and then solidification carried out by drying. Drying means may comprise a convection oven or a microwave oven. The ridge-forming material may also be a curable material such that the ridges are formed by the curable material, and solidification would then be carried out by curing the material. Curing may include application of thermal radiation, electromagnetic radiation (ultraviolet light, visible light, microwave, etc.), particle radiation (e-beam exposure, etc.), or some combination thereof. Curing may also be used in conjunction with drying and may follow the drying process or may be simultaneous with the drying process.

Useful ridge-forming materials include those that can be formed into ridges and, after solidified, are capable of maintaining shape over a variety of processing and handling conditions. For example, the solidified ridge-forming material may need to be resistant to solvent that may be used when coating release agents on the structured surface.

As described above, ridge-forming materials may be thermoplastic materials that are solids at room temperature but are thermally softenable or liquefiable for coating when heated to a sufficient temperature; examples include polyesters, waxes, and silicones. Also as described above, ridge-forming materials may comprise solutions, dispersions, or suspensions of materials in water or organic solvent; polymers are an example. Curable ridge-forming materials include monomers, oligomers, and polymers, any of which may polymerize, crosslink, etc. as described above. Care must be taken when selecting the particular ridge-forming material: the structure must not flow too much prior to post-drying of the material.

Examples of ridge-forming materials include polymer mixtures such as acrylics (ELVACITE, ACRYLOID, PARALOID, DIANAL), esters, urethanes (NEOREZ, DESMOLAC), ureas, silicones, vinyls (UCAR), styrenics, and the like; and curable materials such as (meth)acrylates, vinyl ethers, unsaturated materials, epoxide functional materials, and silicones. In one example, the ridge-forming material comprises a curable mixture of one or more (meth)acrylate monomers and one or more urethane (meth)acrylate oligomers. Particles in the ridge-forming material may also be used and include nanoparticles such as metal oxide nanoparticles.

The ridge-forming material may comprise a release material in order to facilitate release between the structured release liner and a structured adhesive film formed thereon. Alternatively or in addition thereto, the release material may be coated on the structured surface such that the method of manufacturing the structured release liner further comprises coating a release material on the structured surface to form a release layer.

Examples of suitable release materials include silicones which may be radiation curable silicones, such as those described in U.S. Pat. No. 5,527,578 and U.S. Pat. No. 5,858,545, and other reactive silicones, such as those described in WO 00/02966, all incorporated herein by reference. Specific examples include polydiorganosiloxane polyurea copolymers and blends thereof, such as those described in U.S. Pat. No. 6,007,914, incorporated herein by reference. Examples of release coatings include silicone, solvent and solventless types, thermal cure and radiation cure types, condensation cure types and addition cure types, epoxide functional, acrylate functional, silanol functional types, silicone hydride functional types, and release modifiers, such as siloxanes.

Useful silicone release agents include mercapto-functionalized siloxanes having the formula:

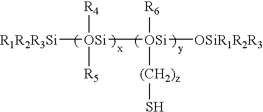

wherein:

x is at least one;

y is at least one and can range from 0.5 to about 80% of (x+y), preferably from 1-20% of (x+y), and most preferably from 3.5-14% of (x+y);

the sum of (x+y) is an integer of 10 or greater;

z can range from 1 to about 16, preferably from 1 to 5 and is preferably 3;

R₁, R₂ and R₃, are monovalent moieties that can independently be the same or different and are selected from the group consisting of alkyl, aryl, alkaryl, alkoxy, alkylamino, hydroxyl, hydrogen, fluoroalkyl, divalent linking groups and are most preferably alkyl moieties;

R₄, R₅, and R₆ are monovalent moieties that can independently be the same or different and are selected from the group consisting of alkyl, aryl, alkaryl, alkoxy, alkylamino, hydroxyl, hydrogen, fluoroalkyl, and are most preferably alkyl moieties.

The molecular weight of the mercapto-functionalized siloxanes can range from about 1000 to about 200,000, for example, from about 5000 to about 50,000.

A particular example of a mercapto-functionalized siloxane is one in which R₁, R₂, R₃, R₄, R₅, and R₆=CH₃; y=3.5-4.5% of (x+y); z=3; and the number average molecular weight (Mn)=8000. This material may be obtained from Shin-Etsu, Inc. under the commercial designation of “KF2001”.

Another example of a suitable release material that may be incorporated into the ridge-forming material or coated to form a release layer is a fluorocarbon material.

Other additives used in the ridge-forming material can include dispersants, colorants, catalysts, surface tension modifiers, blowing agents, and materials used to enhance the bond between the ridge-forming material to the base. Additives may be used to control viscosity, such as silicas, clays, and resins such as vinyl resins (for example those sold under the tradename UCAR), acrylic resins (for example those sold under the tradenames, ACRYLOID, PARALOID, and ELVACITE types), polyester co-resins and modified ureas. Aqueous viscosity modifiers include cellulose ethers, hydrophobically modified cellulose ethers, hydroxyalkyl celluloses, cellulose complexes, polysaccharides, agar, alkali soluble polymers, alkali swellable polymers, nonionic types, nonionic urethanes, alkali swellable emulsion polymers, hydrophobically modified alkali swellable polymers, and carboxyl functional polymers.

The base may comprise any suitable carrier web and may be flexible. Examples include paper such as clay-coated paper or polyethylene-coated paper. Polymeric films may also be used, such as polyester (for example polyethylene terephthalate), polyethylene, and polypropylene (including cast and biaxially oriented polypropylene). The base may comprise single or multiple layers, such as polyethylene-coated polyethylene terephthalate. The base may also have flat and/or structured surfaces such as textured surfaces comprised of random roughness, random pattern of shapes, ordered roughness, ordered pattern of shapes, or combinations thereof. The base may be primed or treated to enhance the adhesion of the ridge-containing layer. Examples of such treatments include, for example, corona, flame, plasma and chemical treatments.

As described below, an adhesive such as an adhesive layer may be contacted with the structured surface of the structured release liner, and a backing may then optionally be applied to the adhesive layer opposite the structured release liner. The adhesive layer and optional backing may then be separated from the structured release liner, resulting in a structure formed on the adhesive layer. This structure is the inverse of that of the structured surface of the structured release liner. The structure formed on the adhesive layer may form air egress channels such that when in contact with a substrate, the air egress channels define a structured bonding surface having exit pathways for air to bleed out from under the adhesive layer when the structured surface of the adhesive layer is adhered to a substrate. The structured adhesive layer and the optional backing may be referred to as a structured adhesive film.

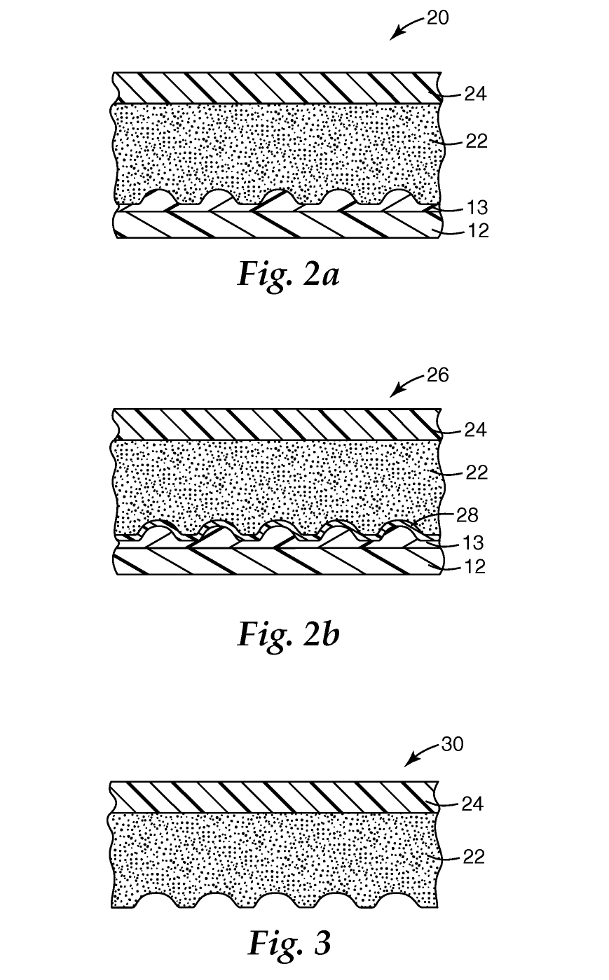

The structured release liners may be used to form laminate constructions comprising an adhesive layer and an optional backing disposed on the liner. FIGS. 2a and 2b show exemplary laminate constructions 20 and 26, respectively, that may be formed using the structured release liner of FIGS. 1a and 1b. In FIG. 2a, adhesive layer 22 is disposed on the structured surface of structured release liner 10, and backing 24 is disposed on the adhesive layer opposite the liner. In this case, the structured release liner would typically have intrinsic release properties such that the adhesive layer could be separated with little or no damage from the liner. In FIG. 2b, release layer 28 is disposed on the structured surface such that the adhesive layer could be separated with little or no damage from the liner.

The adhesive layer may be made by coating an adhesive dissolved or dispersed in a solution onto the structured surface, or a hot melt adhesive may be used by coating it in a molten state onto the structured surface and then cooled to form the adhesive layer. A backing or release liner may then be applied to the adhesive layer opposite the structured surface. Thus, a method of forming a laminate construction may comprise: providing a structured release liner as described above, the at least one ridge forming a structured surface; coating an adhesive on the structured surface to form an adhesive layer; and optionally contacting a backing to the adhesive layer opposite the structured surface. The adhesive layer may comprise a pressure sensitive adhesive as described below.

An adhesive layer may also be formed by contacting an existing adhesive article comprising an adhesive layer disposed on an optional backing, such that the adhesive layer is contacted with the structured surface. Thus, another method of forming a laminate construction may comprise: providing a structured release liner as described above, the at least one ridge forming a structured surface; providing an adhesive article comprising an adhesive layer disposed on an optional backing; and contacting the structured surface with the adhesive layer. The adhesive layer may comprise a pressure sensitive adhesive as described below.

The adhesive is generally a pressure sensitive adhesive which is generally characterized by its properties. Pressure sensitive adhesives are well known to one of ordinary skill in the art to possess properties including the following: (1) permanent tack, (2) adherence to an adherend with no more than finger pressure, (3) sufficient ability to hold onto an adherend, and (4) sufficient cohesive strength to meet the needs of an intended application. Many pressure sensitive adhesives must satisfy these properties under an array of different stress rate conditions.

The pressure sensitive adhesive may be any of those based on natural rubbers, synthetic rubbers, styrene block copolymers, polyvinyl ethers, poly(meth)acrylates (including both acrylates and methacrylates), polyolefins, and silicones. The pressure sensitive adhesive may be aqueous or solvent based, a hot melt type, or a 100% solids coatable type. Furthermore, the pressure sensitive adhesive may comprise a single pressure sensitive adhesive or a combination of two or more pressure sensitive adhesives. The pressure sensitive adhesive may be crosslinked.

Useful poly(meth)acrylic pressure sensitive adhesives are derived from, for example, at least one alkyl(meth)acrylate ester monomer such as, for example, isooctyl acrylate, isononyl acrylate, 2-methyl-butyl acrylate, 2-ethyl-hexyl acrylate and n-butyl acrylate; and at least one optional co-monomer component such as, for example, (meth)acrylic acid, vinyl acetate, N-vinyl pyrrolidone, (meth)acrylamide, a vinyl ester, a fumarate, a styrene macromer, or combinations thereof. Preferably, the poly(meth)acrylic pressure sensitive adhesive is derived from between about 0 and about 20 weight percent of acrylic acid and between about 100 and about 80 weight percent of at least one of isooctyl acrylate, 2-ethyl-hexyl acrylate, or n-butyl acrylate. For example, the poly(meth)acrylic pressure sensitive adhesive may be derived from between about 2 and about 10 weight percent acrylic acid and between about 90 and about 98 weight percent of at least one of isooctyl acrylate, 2-ethyl-hexyl acrylate, or n-butyl acrylate. Another example comprises from about 2 weight percent to about 10 weight percent acrylic acid, and about 90 weight percent to about 98 weight percent of isooctyl acrylate. For yet another example, the adhesive is derived from between about 94-98 weight percent of isooctyl acrylate, 2-ethyl hexyl acrylate, n-butyl acrylate, or 2-methyl butyl acrylate, and 2-6 weight percent (meth)acrylamide.

Additives to the pressure sensitive adhesive may be used to impart, control, adjust, etc. desired properties such as tackiness and cohesive strength. For example, tackifiers and/or detackifiers may be used; for example, useful tackifiers include rosin ester resins, aromatic hydrocarbon resins, aliphatic hydrocarbon resins, and terpene resins. Other materials can be added for special purposes, including, for example, oils, plasticizers, fillers, antioxidants, UV stabilizers, hydrogenated butyl rubber, pigments, and curing agents.

The backing may be paper or any film, for example graphic films such as polyvinyl chloride. The backing may be imaged using any commercial technique, including electrophotography, inkjet, screen printing, flexography, electronic cutting, or other imaging or graphic techniques. Contacting a backing to the adhesive layer may comprise laminating the backing to the adhesive layer already formed on the structured release liner.

FIG. 3 shows an exemplary structured adhesive film 30 that may be formed by separating the adhesive layer/backing from the structured release liner of FIGS. 1a and 1b. Structured adhesive films may be laminated to a substrate by hand, with the use of a squeegee or roller, or other conventional technique.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

Table of Abbreviations

| Abbreviation or | |
|---|---|
| Trade Designation | Description |
| Photocurable | see below |
| Mixture 1 | |
| Photocurable | see below |
| Mixture 2 | |
| Photocurable | 100% of 3M ™ Screen Printing Ink Halftone Base 9797 |
| Mixture 3 | commercially available from 3M Company, St. Paul, MN. |
| Photocurable | Bondo UV Body Filler 752 (styrene/polyester photocurable |
| Mixture 4 | creamy paste composition) commercially available from Bondo |
| | Corporation, Atlanta, GA. |
| Amorphous Silica | CAB-O-SIL M5 amorphous silica commercially available from |
| | Cabot, Inc., Boston, MA. |
| Paper stock | 78 pound basis weight clay coated paper stock, 33 centimeters |
| | (13 inches) wide with a thickness of 117 micrometers (4.6 mils) |
| | commercially available from Boise Paper, Boise, ID. |
| Silicone release | A mixture of 66.9% by weight heptane, 16.9% by weight |
| formulation | methyl ethyl ketone, 14.7% by weight SYL-OFF 292, 0.4% by |
| | weight SYL-OFF 297, 0.4% by weight SYL-OFF C4-2117, and |
| | 0.6% by weight SYL-OFF 176. (SYL-OFF commercially |
| | available from Dow Corning, Midland, MI). |
| PSA solution | A 25% solids solution in ethyl acetate of a 93:7 iso-octyl |
| | acrylate/acrylic acid PSA containing 0.4 parts of bisamide |
| | crosslinker described in U.S. Pat. No. 5,296,277 (Wilson et al.) as |
| | Adhesive Solution 5 diluted to 25% solids with ethyl acetate. |
| PVC | Primed polyvinyl chloride film of 51 micrometers (2 mils) |
| | thickness commercially available from 3M Company, St. Paul, |
| | MN. |
| Adhesive Film | Adhesive coated graphic film with release liner, commercially |
| | available as “SCOTCHCAL Graphic Marking Film 1330-526” |
| | from 3M Company, St. Paul, MN. |
| Additive 1 | TEGO RAD 2650 acrylated polysiloxane, commercially |
| | available from Degussa AG, Essen, Germany |
| Additive 2 | TEGO RAD 2700 acrylated polysiloxane, commercially |
| | available from Degussa AG, Essen, Germany |
| Additive 3 | a mercaptofunctional siloxane with 4–5 mole % mercapto |
| | functionality commercially available from Shin-Etsu as KF2001 |

### Test Methods

### WYKO Analysis

Adhesive samples were evaluated using interferometry microscopy using a WYKO RST surface profiler (WYKO Corp., Tucson, Ariz.). This technique used light interferometry to evaluate the surface topography of a sample. Light was reflected from essentially horizontal surfaces, and thus the dimensions of the ridges could be determined.

### Indent Panel Test

A circular indent was made in 0.7 mm thick aluminum test panel using a hemispherical drop hammer with a tip diameter of 2.5 cm. The indent was about 2.8 cm diameter at the plane of the panel and was about 0.6 cm deep. A 7.5 cm by 7.5 cm test sample to be tested was centered over the indent and applied flat onto the panel and taut over the indent. A PA-1 Hand Applicator with a protective sleeve (SA-1, available from 3M) was used to press the sample onto the panel using a mass of about 1 kg. Then the film was pressed with a thumb into the depressed indent. At least 3 kg of mass was applied. The ability of the sample to conform into the indent and uniformly contact the depressed panel indent was rated as follows:
0—would not conform significantly into the indent against the entrapped air;
1—could be pressed down into the indent to the extent of about 50%;
2—could be pressed down to conform with much of the indent leaving small air bubbles;
3—could be pressed down to conform slowly (greater than 5 seconds) and completely into the indent;
4—could be pressed down to conform swiftly (less than 5 seconds) and completely into the indent.

### Rivet Panel Test

A test sample was manually pressed over a 12 mm diameter by 2.5 mm high rounded rivet onto a Fruehauf flat panel (approximately 10 cm by 30 cm (4″×12″) panel having 4 evenly spaced rivets along the length of the panel, 3004-H291 A1/w4 rivets, w/BASF 42W454 Polar White paint (Michaud Co.)) with rivets by starting at the edges of the sample 3.8 cm from the center of the rivet. The sample was pressed down, using both thumbs, with thumb pressure (approximately 750 g for each thumb) at the periphery using a circular motion to entrap a large air pocket under the film. The film was then pressed in at the edge of the air pocket towards the rivet keeping thumbs at opposite sides of the rivet and making half-circular motions in alternating directions with decreasing radii to keep the thumbs along the margin of the pocket (approximately 750 g for each thumb). The force was limited so as not to burst the film. This procedure ensured that a large air pocket was formed under the sample and was prevented from being pushed under the film, to the sample edge by debonding of the PSA. The time required for dissipating the air pocket and conforming the film to within 2 mm of the rivet was determined. If a large air pocket remained after 5 minutes of working the film, the diameter of the air pocket was determined. Samples with best air dissipation generally required less than about 30 to 60 seconds to conform the film up to the rivet. Poorest samples entrapped about a 35 mm (or larger) air pockets after 5 minutes of working application.

### Release from Liner

Release from liner was evaluated by comparing the release forces obtained from hand peeling a film from a PSA/PVC laminate and the liner of the Adhesive Film. The ratings were: very high (aggressive bond to liner); high (may be too aggressive for many applications); moderate (removable); easy-moderate (typical); easy (typical); very easy (typical or easier). In case of very easy release it is also noted whether the released PSA is functional, i.e. still tacky, indicating that there was not significant transfer of release material to the PSA.

### Air Bubble Release

Air bubble release was evaluated by applying a small piece of film backing/PSA laminate onto a flat panel, applying finger pressure from edges toward center to entrap some bubbles, and pressing at edges of bubbles to attempt to flatten graphic against panel. Results are listed as “Yes” or “No” if air bubbles were released or not.

### Photocurable Mixture 1

Photocurable Mixture 1 was prepared by combining the following given in parts by weight:

| | |
|---|---|
| 40.4 | oligomer prepared from isophorone diisocyanate, caprolactone diol, |
| | and caprolactone triol and end-capped with hydroxyethyl |
| | acrylate, Mₙ approximately 1500; |
| 15.2 | N-vinyl caprolactam |
| 8.4 | oligomer prepared from butyl isocyanate and hydroxyethyl acrylate |
| 8.1 | ethoxyethoxyethyl acrylate |
| 7.6 | hexanediol diacrylate |
| 7.3 | isooctyl acrylate |
| 5 | amorphous silica |
| 3.8 | IRGACURE 184 (from Ciba Specialty Chemicals) |
| 3.8 | 50:50 TINUVIN 292 and 1130 (from Ciba Specialty Chemicals) |
| 0.5 | STABOXOL I (Rhein Chemie) |

### Photocurable Mixture 2

Photocurable Mixture 2 was prepared by combining the following given in parts by weight:

| | |
|---|---|
| 40.8 | oligomer prepared from isophorone diisocyanate, caprolactone diol, |
| | and caprolactone triol and end-capped with hydroxyethyl |
| | acrylate, Mₙ approximately 1500; |
| 15.4 | N-vinyl caprolactam |
| 8.5 | oligomer prepared from butyl isocyanate and hydroxyethyl acrylate |
| 8.2 | ethoxyethoxyethyl acrylate |
| 7.7 | hexanediol diacrylate |
| 7.4 | isooctyl acrylate |
| 4 | amorphous silica |
| 3.8 | IRGACURE 184 (from Ciba Specialty Chemicals) |
| 3.8 | 50:50 TINUVIN 292 and 1130 (from Ciba Specialty Chemicals) |
| 0.5 | STABOXOL I (Rhein Chemie) |

### Example 1

A coating apparatus was set up by taping each end of Number 75 Mayer rod to a coater platform to hold the rod stationary. A Number 75 Mayer rod typically gives a coating with a wet thickness of 171 micrometers (6.75 mils). Paper stock was inserted between the rod and the platform. Photocurable Mixture 1 was coated onto the paper behind the rod and the paper pulled under the rod. The coated paper was then sent 2 times though a UV curing unit (American Ultraviolet Company processor) at 16.5 meters per minute (55 feet per minute) and 0.300 Joules/cm² (Uvicure UV curing Radiometer, Electronic Instrumentation Technology Inc.) for each pass. The cured coating had linear ridges at about 5 per centimeter (13 per inch) and a thin layer of UV cured coating between the ridges. The ridge dimensions were about 1,400 micrometers wide and 336 micrometers high.

### Example 2

The procedure described for Example 1 was repeated except that a Number 5 Mayer rod was used. A Number 5 Mayer rod typically gives a coating with a wet thickness of 11.4 micrometers (0.45 mils). The cured coating had linear ridges at about 28 per centimeter (71 per inch). The ridge dimensions were about 170 to about 265 micrometers wide and an average of 24 micrometers high.

### Example 3

The procedure described for Example 2 was repeated except that Photocurable Mixture 2 was used. The material coated smoothly and cured well after one pass at 9.1 meters per minute (30 feet per minute) and 0.510 Joules/cm². The cured layer had linear ridges of about 28 to 32 per centimeter (71 to 82 per inch). The ridge dimensions were determined to be about 211 to 247 micrometers wide and an average of 20 micrometers high. This sheet was coated with a thin layer of Silicone Release Formulation and oven cured to form a liner. PSA Solution was coated onto this liner at 178 micrometers (7 mils) wet thickness and dried for 10 minutes in a 71° C. (160° F.) oven. A film backing of PVC was laminated to the dried PSA coating. The film backing/PSA laminate was easily removed from the liner. WYKO analysis of the PSA surface showed continuous grooves with an average depth of about 12 micrometers. The Rivet Panel test required only 18 to 20 seconds, the Indent Panel test gave a rating of 4.

### Example 4

The procedure described for Example 3 was repeated except that Photocurable Mixture 3 was used. The viscous grease-like material was best coated by spreading a layer of the material over the paper prior to pulling under the rod. The cured layer appeared to be continuous and had a yellowish color. The yellowish cured ridge dimensions were determined to be about 220 microns wide and 28 microns high and followed the shape of the coating rod grooves. This sheet was coated with a thin layer of Silicone Release Formulation and oven cured to form a liner. PSA Solution was coated onto this liner at 178 micrometers (7 mils) wet thickness and dried for 10 minutes in a 71° C. (160° F.) oven. A film backing of PVC was laminated to the dried PSA coating. The film backing/PSA laminate was easily removed from the liner. The Rivet Panel test required only 18 seconds and the Indent Panel test gave a rating of 4.

### Example 5

The procedure described for Example 3 was repeated except that Photocurable Mixture 4 was used. The ridge dimensions were determined to be about 200 to 300 micrometers wide and about 17 to 24 micrometers high. This sheet was coated with a thin layer of Silicone Release Formulation and oven cured to form a liner. PSA Solution was coated onto this liner at 178 micrometers (7 mils) wet thickness and dried for 10 minutes in a 71° C. (160° F.) oven. A film backing of PVC was laminated to the dried PSA coating. The film backing/PSA laminate was easily removed from the liner. WYKO analysis of the PSA surface showed continuous grooves with an average depth of 18 micrometers. The Rivet Panel test required only 20 seconds, the Indent Panel test gave a rating of 3.

### Examples 6 and 7

A mixture of Photocurable Mixture 2 and Additive 1 at 5% by weight was coated onto Paper Stock as described in Example 2. This sheet was coated with a thin layer of Silicone Release Formulation and oven cured to form a liner. Laminate constructions were then prepared as follows. For Example 6, the PSA solution and PVC backing were used as described in Example 3. For Example 7, using the Adhesive Film, the release layer was removed to expose the adhesive layer disposed on a backing, which was then laminated to the liner.

### Examples 8 and 9

A mixture of Photocurable Mixture 2 and Additive 2 at 5% by weight was coated onto Paper Stock as described in Example 2. This sheet was coated with a thin layer of Silicone Release Formulation and oven cured to form a liner. Laminate constructions were then prepared as follows. For Example 8, the PSA solution and PVC backing were used as described in Example 3. For Example 9, using the Adhesive Film, the release layer was removed to expose the adhesive layer disposed on a backing, which was then laminated to the liner.

### Examples 10 and 11

A mixture of Photocurable Mixture 2 and Additive 3 at 5% by weight was coated onto Paper Stock as described in Example 2. This sheet was coated with a thin layer of Silicone Release Formulation and oven cured to form a liner. Laminate constructions were then prepared as follows. For Example 10, the PSA solution and PVC backing were used as described in Example 3. For Example 11, using the Adhesive Film, the release layer was removed to expose the adhesive layer disposed on a backing, which was then laminated to the liner.

### Comparative Examples C1-C2

Photocurable Mixture 2 was coated onto Paper Stock as described in Example 2. This sheet was coated with a thin layer of Silicone Release Formulation and oven cured to form a liner. Laminate constructions were then prepared as follows. For C1, the PSA solution and PVC backing were used as described in Example 3. For C2, using the Adhesive Film, the release layer was removed to expose the adhesive layer disposed on a backing, which was then laminated to the liner.

### Comparative Examples C3-C4

The Paper Stock was used as the liner and laminate constructions were prepared as follows. For C3, the PSA solution and PVC backing were used as described in Example 3. For C4, using the Adhesive Film, the release layer was removed to expose the adhesive layer disposed on a backing, which was then laminated to the liner.

### Comparative Examples C5-C6

The liner from the Adhesive Film was used as the liner and laminate constructions were prepared as follows. For C5, the PSA solution and PVC backing were used as described in Example 3. For C6, using the Adhesive Film, the release layer was removed to expose the adhesive layer disposed on a backing, which was then laminated to the liner.

Examples 6-11 and Comparative Examples C1-C6 were tested using the Release From Liner Test and Air Bubble Release tests described above. The results are summarized in Table 1.

TABLE 1

| | | | | Air |
|---|---|---|---|---|
| | Structured Adhesive | Structured | Release From | Bubble |
| Ex. | Layer | Adhesive Film | Liner | Release |
| 6 | Paper Stock with | PSA/PVC | high | NT |
| | PCM 2 + Additive 1 | | | |
| 7 | Paper Stock with | Adhesive Film | very easy, PSA | NT |
| | PCM 2 + Additive 1 | | functional | |
| 8 | Paper Stock with | PSA/PVC | moderate | Yes |
| | PCM 2 + Additive 2 | | | |
| 9 | Paper Stock with | Adhesive Film | very easy, PSA | NT |
| | PCM 2 + Additive 2 | | functional | |
| 10 | Paper Stock with | PSA/PVC | easy - moderate | Yes |
| | PCM 2 + Additive 3 | | | |
| 11 | Paper Stock with | Adhesive Film | very easy, PSA | Yes |
| | PCM 2 + Additive 3 | | functional | |
| C1 | Paper Stock with | PSA/PVC | very high | NT |
| | PCM2 | | | |
| C2 | Paper Stock with | Adhesive Film | very high | NT |
| | PCM2 | | | |
| C3 | Paper Stock | PSA/PVC | very high | No |
| C4 | Paper Stock | Adhesive Film | high | No |
| C5 | Liner from | PSA/PVC | easy - moderate | No |
| | Adhesive Film | | | |
| C6 | Liner from | Adhesive Film | easy | No |
| | Adhesive Film | | | |

NT = not tested

Various modifications and alterations of the present invention will become apparent to those skilled in the art without departing from the spirit and scope of the invention.

What is claimed is:

1. A method of manufacturing a structured release liner, the method comprising:
providing a base;
providing a ridge-forming material;
coating the ridge-forming material on the base;
forming the ridge-forming material into at least one ridge using a coating bar having a profile; and
solidifying the ridge-forming material.

2. The method of claim 1, wherein coating the ridge-forming material on the base and forming the ridge-forming material into at least one ridge using a coating bar are carried out simultaneously.

3. The method of claim 1, the at least one ridge having a height of from about 3 micrometers to about 500 micrometers.

4. The method of claim 1, the at least one ridge having a width of from about 15 micrometers to about 2000 micrometers.

5. The method of claim 1, the at least one ridge comprising a first ridge disposed adjacent a second ridge, the first ridge having a first center point, the second ridge having a second center point, and the distance between the first and second center points is from about 150 micrometers to about 5100 micrometers.

6. The method of claim 1, the ridge-forming material comprising a curable mixture of monomers and/or oligomers.

7. The method of claim 6, the ridge-forming material comprising particles.

8. The method of claim 1, the ridge-forming material comprising a silicone or fluorocarbon release material.

9. The method of claim 8, the silicone release material comprising a mercapto-functionalized siloxane.

10. A method of forming a laminate construction, the method comprising:
providing a structured release liner prepared according to the method of claim 1, the at least one ridge forming a structured surface;
coating an adhesive on the structured surface to form an adhesive layer; and
optionally contacting a backing to the adhesive layer opposite the structured surface.

11. The method of claim 10, the adhesive layer comprising a pressure sensitive adhesive.

12. A method of forming a laminate construction, the method comprising:
providing a structured release liner prepared according to the method of claim 1, the at least one ridge forming a structured surface;
providing an adhesive article comprising an adhesive layer; and
contacting the structured surface with the adhesive layer.

13. The method of claim 12, the adhesive layer comprising a pressure sensitive adhesive.

14. The method of claim 1, the at least one ridge forming a structured surface, and the method comprising coating a release material over the structured surface to form a release layer, the release material comprising a silicone or fluorocarbon release material.

15. A method of forming a laminate construction, the method comprising:
providing a structured release liner prepared according to the method of claim 14, the at least one ridge forming a structured surface;
coating an adhesive on the structured surface to form an adhesive layer; and
optionally contacting a backing to the adhesive layer opposite the structured surface.

16. The method of claim 15, the adhesive layer comprising a pressure sensitive adhesive.

17. A method of forming a laminate construction, the method comprising:
providing a structured release liner prepared according to the method of claim 14, the at least one ridge forming a structured surface;
providing an adhesive article comprising an adhesive layer; and
contacting the structured surface with the adhesive layer.

18. The method of claim 17, the adhesive layer comprising a pressure sensitive adhesive.
